(19) United States
(12) Patent Application Publication
(10) Pub. No.: US 2019/0322011 A1
(43) Pub. Date: Oct. 24, 2019

(54) MOLD FOR MOLDING URETHANE FOAM AND METHOD FOR PRODUCING URETHANE FOAM PRODUCT USING THE SAME

(71) Applicant: HOWA KASEI CO., LTD., Nagoya-Shi (JP)

(72) Inventor: Hidekazu Oike, Nagoya-Shi (JP)

(73) Assignee: HOWA KASEI CO., LTD., Nagoya-Shi (JP)

(21) Appl. No.: 16/021,190

(22) Filed: Jun. 28, 2018

(30) Foreign Application Priority Data
Apr. 18, 2018 (JP) 2018-079572

(51) Int. Cl. B29C 44/58

(52) U.S. Cl. CPC B29C 44/58; B29K 2075/00

(57) ABSTRACT

To provide a mold for molding urethane foam capable of producing a urethane foam product without using a mold release agent, and a method for producing a urethane foam product using the same. The mold for molding urethane foam according to the present invention includes polypropylene mold materials 12, 13 that constitute upper and lower molding surfaces 16, 19 and are attached respectively to opposite surfaces of an upper mold frame 10 and a lower mold frame 11 that are openable and closable. The mold has excellent releasability and can be used to produce urethane foam products without using a mold release agent.

### BACKGROUND

### 1. Technical Field

The present invention relates to a mold for molding urethane foam and a method for producing a urethane foam product using the same.

### 2. Related Art

Conventionally, urethane foam products have been widely used in interior parts for automobiles and the like. These urethane foam products are molded by providing a urethane stock solution containing a foaming agent into a mold cavity defined by upper and lower molds that are openable and closable, and heating and foaming the urethane stock solution.

The molds such as these upper and lower molds are made of metal such as aluminum or steel, or hard resin such as epoxy resin. Urethane has strong adhesiveness to various materials. Thus, urethane adheres to the molding surfaces when used as it is. When the mold is opened, a surface of the product would peel off, and the product cannot be molded properly.

Hence, a method of enhancing releasability by spraying or applying a mold release agent to a molding surface and releasing a urethane foam product from a mold, as disclosed in JP 2009-40048 A and JP 2010-23269 A, is common. Wax-type and silicon-type agents are widely used as the mold release agent.

However, since the mold release agent is scattered around, the working environment around the molding machine inevitably deteriorates, and it is necessary to provide a powerful ventilation facility to secure the working environment. However, much cost is required to recover and dispose of the mold release agent discharged from the ventilation facility.

In addition, since the mold release agent is gradually deposited on the molding surfaces of the mold, there are problems that the smoothness of the molding surface is lost, and that repeated molding causes damage of the mold and roughness of the surface skin of the product. Therefore, it is also necessary to remove the deposited mold release agent periodically.

Since there are various problems with the mold release agent as described above, attempts have been made to produce a urethane foam product by applying a mold release film, instead of the mold release agent, onto the molding surface. However, such a mold release film is prone to wrinkling, and it is not easy to realize stable production. In fact, under such circumstances, mold release agents have been continuously used for many years in the manufacturing industry of urethane foam products.

### SUMMARY

An object of the present invention is to provide a mold for molding urethane foam that solves the conventional problems described above and can be used to produce a urethane foam product without using a mold release agent, and a method for producing a urethane foam product using the same.

The mold for molding urethane foam according to the present invention, which has been made in order to solve the above problems, includes a lower mold frame, an upper mold frame that is openable and closable against the lower mold frame, a mold material made of polypropylene that is attached to an upper surface of the lower mold frame and that constitutes a molding surface, and a mold material made of polypropylene that is attached to an undersurface of the upper mold frame and that constitutes a molding surface.

Note that it is preferable to adopt a structure in which gaps for absorbing thermal expansion of the polypropylene mold materials are provided between the polypropylene mold materials and the mold frames.

The method for producing a urethane foam product according to the present invention, which has been made in order to solve the above problems, includes molding a urethane foam product, without using a mold release agent, by using a mold for molding urethane foam including polypropylene mold materials that constitute upper and lower molding surfaces and are attached respectively to opposite surfaces of an upper mold frame and a lower mold frame that are openable and closable.

The mold for molding urethane foam according to the present invention includes upper and lower molding surfaces that are made of a polypropylene mold material. Since polypropylene has no adhesiveness and shows excellent releasability from urethane as well, it is possible to stably produce urethane foam products without conventionally using a mold release agent. Therefore, the present invention can improve the work environment around the molding machine. Further, since no mold release agent is necessary, the molding cost can be lowered. Further, since the molding surface is not roughened by the mold release agent, the surface skin of the product is smooth, and the molding quality can be improved.

### BRIEF DESCRIPTION OF DRAWINGS

FIG. 1 is a front view showing a state in which a mold for molding urethane foam according to an embodiment is opened;

FIG. 2 is a side view showing a state in which the mold for molding urethane foam according to the embodiment is closed;

FIG. 3 is a central longitudinal sectional view of FIG. 1; and

FIG. 4 is a cross-sectional view showing a state in which the mold for molding urethane foam according to the embodiment is closed.

### DETAILED DESCRIPTION

Embodiments of the present invention will be described below.

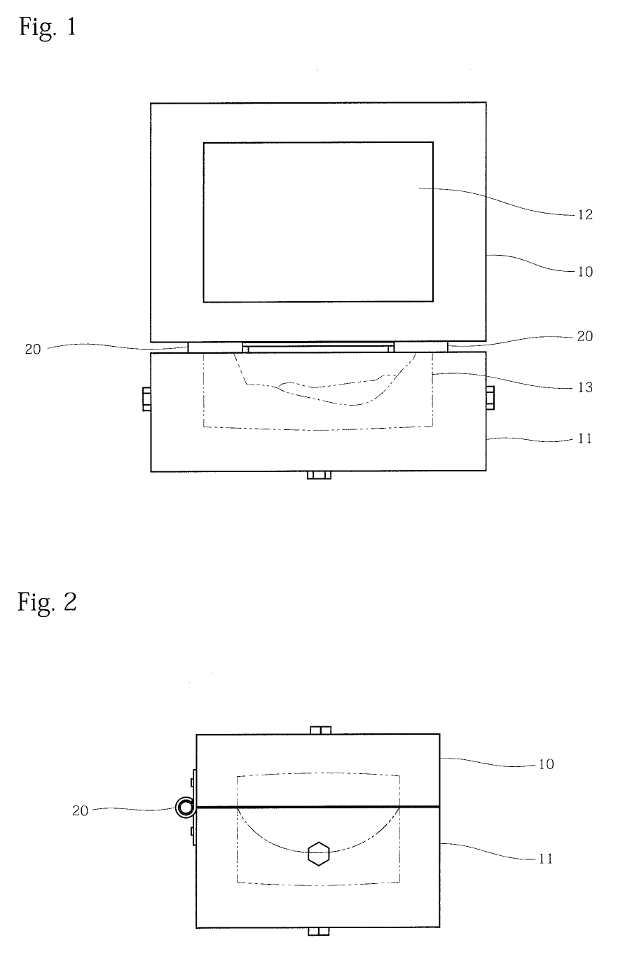

FIG. 1 is a front view showing a state in which a mold for molding urethane foam is opened, and FIG. 2 is a sectional view showing a state in which the mold is closed. In these drawings, reference numeral 10 denotes an upper mold frame, and reference numeral 11 denotes a lower mold frame. The upper and lower mold frames 10, 11 are made of metal such as an aluminum material or a steel material, or hard resin such as epoxy resin. One side of the upper mold frame 10 and one side of the lower mold frame 11 are connected together by a hinge 20, so that the upper and lower mold frames 10, 11 are closable as shown in FIG. 2. On the opposite side of the hinge 20, a clamping means (not shown) is provided. A polypropylene mold material 12 is attached to a lower surface of the upper mold frame 10, and a polypropylene mold material 13 is attached to an upper surface of the lower mold frame 11.

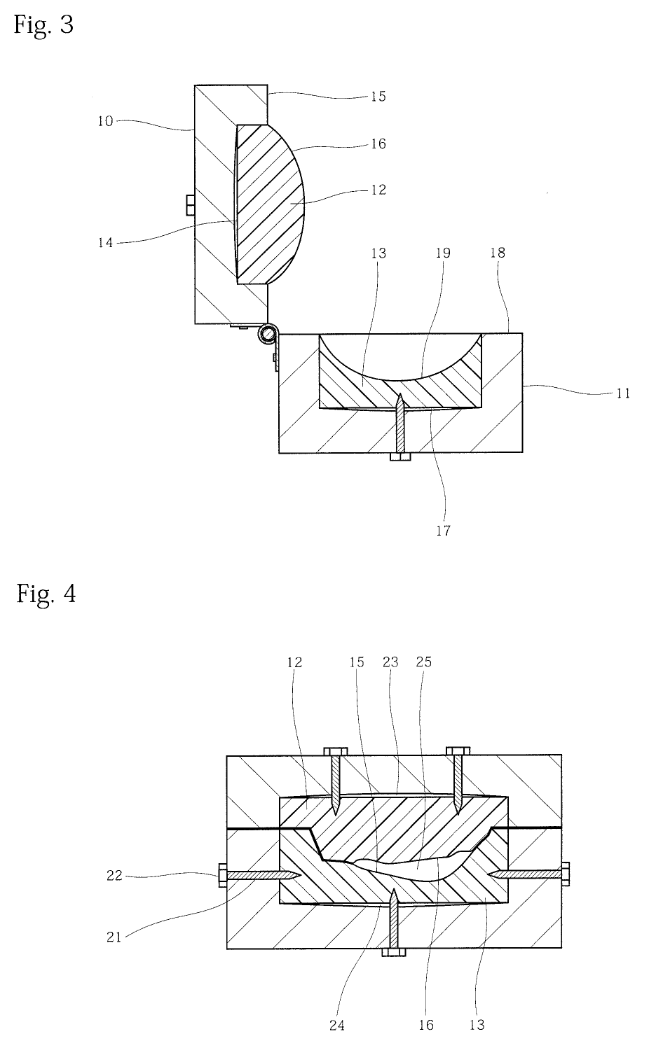

These mold materials 12, 13 are made of a polypropylene resin and have a block shape. As shown in FIG. 3, the mold material 12 has its base fixed to a concave portion 14 formed on a lower side of the upper mold frame 10 and is provided with a molding surface 16 projecting further than a mating surface 15 of the mold frame 10. Further, the mold material 13 is attached so as to be embedded in a concave portion 17 formed on the upper surface of the lower mold frame 11, and is provided with a molding surface 19 recessed further than a mating surface 18 of the mold frame 11. In this embodiment, the molding surfaces 16 and 19 are formed by cutting a block of polypropylene using an NC processing machine, but, needless to say, the method for processing the molding surfaces 16 and 19 is not limited to this. In the case of mass production, the polypropylene mold materials 12, 13 can be molded using a metal mold.

Polypropylene is a resin obtained by polymerizing propylene, and shows the most excellent heat resistance among many resins. Also, polypropylene has poor adhesiveness due to its lower surface free energy, and does not adhere to urethane resin to be foam-molded at 40° C. to 50° C. However, no block-shaped polyethylene resin has been used so far, as a mold material to constitute the upper and lower molding surfaces 16, 19.

In this embodiment, the polypropylene mold materials 12, 13 are attached respectively to the mold frames 10, 11 using bolts 22 as shown in FIG. 4. Specifically, bolt holes 21 are formed at a plurality of places in the mold materials 12, 13, and self-tapping bolts 22 having a sharp tip are screwed from outside so that the tips thereof are bitten and screwed into the mold materials 12, 13. However, the method is not limited to this. Further, the positions where the mold materials 12, 13 are fixed and the number of the bolts 22 can be appropriately determined in consideration of the shapes of the upper and lower molding surfaces 16, 19 and the size of the entire mold.

Since the polypropylene mold materials 12, 13 are heated to 40° C. to 50° C. during foam-molding, when the mold materials 12, 13 are tightly fixed into the concave portions 14, 17 of the mold frames 10, 11 with no gaps, the mold materials 12, 13 are deformed by thermal expansion so that the shapes of the molding surfaces 16, 19 may not be maintained properly. Therefore, it is preferable to provide gaps 23, 24 for absorbing the thermal expansion of the mold materials between the polypropylene mold materials 12, 13 and the mold frames 10, 11.

In order to mold a urethane foam product using the mold for molding urethane foam of the present invention, firstly, the upper mold frame 10 and the upper mold material 12 are opened upward, and a urethane stock solution containing a foaming agent is injected onto the molding surface 19 of the lower mold material 13. In the present invention, unlike the conventional method, it is unnecessary to spray or apply a mold release agent onto the molding surfaces 16, 19. Next, the upper mold frame 10 and the upper mold material 12 are closed and clamped with the lower mold material 13 to define a molding cavity 25 between the molding surface 16 of the upper mold material 12 and the molding surface 19 of the lower mold material 13. Then, the urethane stock solution is heated and foamed, so that a urethane foam product conforming to the shape of the molding cavity 25 is molded.

In this manner, the urethane foam product is molded inside the molding cavity 25. Since both the upper and lower molding surfaces 16, 19 are made of polypropylene, the molded urethane foam product does not adhere to the molding surfaces 16, 19. Therefore, once the upper mold frame 10 and the mold material 12 are subsequently opened upward, the urethane foam product can be released therefrom without damaging the product.

As described above, in the present invention, urethane foam products can be stably produced without using a mold release agent. Therefore, the present invention can improve the working environment around the molding machine, and additionally, does not require a conventional strong ventilation facility or an operation of recovering the mold release agent discharged from the ventilation facility. Further, since no mold release agent is necessary, the molding cost can be lowered.

Furthermore, unlike conventional cases, since no mold release agent is deposited on the molding surfaces 16, 19, there is no need to clean the mold for molding, and additionally, the molding surfaces 16, 19 are not roughened by the mold release agent attached thereto, so that the surface skin of the product is smooth, and molding quality can be improved. Therefore, according to the present invention, it is possible to solve the problems faced by the manufacturing industry of urethane foam products for many years.

What is claimed is:

1. A mold for molding urethane foam comprising:
a lower mold frame;
an upper mold frame that is openable and closable against the lower mold frame;
a mold material made of polypropylene that is attached to an upper surface of the lower mold frame and that constitutes a molding surface; and
a mold material made of polypropylene that is attached to an undersurface of the upper mold frame and that constitutes a molding surface.

2. The mold for molding urethane foam according to claim 1, wherein gaps for absorbing thermal expansion of the polypropylene mold materials are provided between the polypropylene mold materials and the mold frames.

3. A method for producing a urethane foam product, the method comprising molding a urethane foam product, without using a mold release agent, by using a mold for molding urethane foam including polypropylene mold materials that constitute upper and lower molding surfaces and are attached respectively to opposite surfaces of an upper mold frame and a lower mold frame that are openable and closable.
